(19) United States
(12) Patent Application Publication
(10) Pub. No.: US 2022/0379269 A1
(43) Pub. Date: Dec. 1, 2022

(54) HIGH PERMEABILITY FORWARD OSMOSIS MEMBRANE CONTAINING SILICA NANOPARTICLES AND MANUFACTURING METHOD THEREOF

(71) Applicant: NATIONAL KAOHSIUNG UNIVERSITY OF SCIENCE AND TECHNOLOGY, KAOHSIUNG CITY (TW)

(72) Inventors: YI-LI LIN, KAOHSIUNG CITY (TW); TRUC-QUYNH NGUYEN, KAOHSIUNG CITY (TW); KUO-LUN TUNG, KAOHSIUNG CITY (TW); CHENG-DI DONG, KAOHSIUNG CITY (TW); CHIU-WEN CHEN, KAOHSIUNG CITY (TW); CHUNG-HSIN WU, KAOHSIUNG CITY (TW)

(21) Appl. No.: 17/518,110

(22) Filed: Nov. 3, 2021

(30) Foreign Application Priority Data
May 31, 2021 (TW) 110119702

(51) Int. Cl. B01D 69/14; B01D 71/02; B01D 69/02; B01D 69/12; B01D 71/56; B01D 61/00

(52) U.S. Cl. CPC B01D 69/148; B01D 71/027; B01D 69/02; B01D 69/125; B01D 71/56; B01D 61/002; B01D 2325/20; B01D 2325/04

(57) ABSTRACT

The invention discloses a forward osmosis (FO) membrane containing silica nanoparticles having high permeate water flux and its manufacturing method. The FO membrane containing a plurality of silica nanoparticles comprises a substrate layer made of polysulfone and a polyamide layer disposed on the substrate layer. In the course of manufacturing the polyamide layer on the substrate layer by interfacial polymerization, the plurality of silica nanoparticles with different properties is added into the polyamide layer to obtain the FO membrane containing silica nanoparticles having high permeability and solute selectivity.

### 1. FIELD OF THE INVENTION

The present invention discloses a forward osmosis membrane containing silica nanoparticles and a method for manufacturing the same by addition of proper dosage of silica nanoparticles into the forward osmosis membrane to increase the water permeate flux.

### 2. DESCRIPTION OF RELATED ART

Forward osmosis (FO) is an emerging membrane-based separation is process with a range of possible water treatment applications, utilizing the osmotic pressure difference induced by different solute concentrations between the feed and draw solutions on the two sides of a forward osmosis (FO) membrane for the purposes of separation. The advantages of FO technique includes very low energy consumption during operation and mitigated accumulation of pollutants on the membrane surface. Therefore, the FO technique can be used for the treatment of high-intensity inflow water that cannot be processed by a traditional pressure driven membrane separation process, such as landfill leakage, high concentrations of food or medical wastewater, and drug transportation. However, the FO technique has a major challenge of wide application, which is insufficient water permeate flux. Accordingly, increasing water permeate flux of a FO membrane is essential for the application of FO technique nowadays.

### SUMMARY OF THE INVENTION

The present invention discloses a FO membrane containing silica nanoparticles and a method of manufacturing the same. The FO membrane containing silica nanoparticles comprises a substrate layer and a polyamide layer disposed on the substrate layer, wherein the polyamide layer comprises a plurality of silica nanoparticles. The manufacturing method comprises steps of (a) preparing a substrate layer and (b) manufacturing a polyamide layer on the substrate layer by interfacial polymerization, wherein a plurality of silica nanoparticles are added into the polyamide layer and evenly distributed therein.

In an embodiment of the present invention, the polyamide layer comprises 0.5 to 1.5 wt % of silica nanoparticles.

In an embodiment of the present invention, the silica nanoparticles are 3-aminopropyltriethoxysilane modified silica nanoparticles.

In an embodiment of the present invention, the substrate layer is made of polysulfone.

In an embodiment of the present invention, the FO membrane containing silica nanoparticles has a thickness ranging from 60 to 90 μm.

Accordingly, the FO membrane of the present invention has considerably high water permeate flux, low reverse solute flux, and high selectivity, which can reduce the operating time and energy consumption simultaneously. Therefore, the present invention can be well applied in wastewater recovery to significantly increase the efficiency of wastewater recycling and reuse.

### BRIEF DESCRIPTION OF THE DRAWINGS

FIG. 1 is a schematic diagram showing the mechanism of modifying fumed silica by using APTES;

FIGS. 2A-2C show the scanning electron microscopic (SEM) images of different FO membranes;

FIGS. 3A-3D show the SEM images of cross section of different FO membranes;

FIG. 4 is the ATR-FTIR spectra of different FO membranes;

FIG. 5 is the ATR-FTIR spectra of different FO membranes;

FIGS. 6A-6H show SEM pictures and three-dimensional (3D) images of different FO membranes;

FIG. 7 is a schematic diagram of the filtering module used for testing the performance of FO membrane;

FIG. 8 shows the water permeate flux and reverse salt flux of different FO membranes;

FIGS. 9A-9B show the effects of silica types and dosages on the water permeate flux and reverse salt flux of the FO membranes;

FIGS. 10A-10C show the effects of different test conditions on water permeate flux and reverse salt flux of FO membranes;

FIGS. 11A-11B is a regression analyzing diagram of water permeate flux versus water recovery rate of FO membranes under different test conditions.

### DETAILED DESCRIPTION OF THE PREFERRED EMBODIMENT

To provide a thorough understanding of the present invention, an exemplary embodiment of the present invention will be described in detail with reference to the accompanying drawings.

1. Preparation of Silica Nanoparticles

In the following embodiments, various types of silica nanoparticles are used, including fumed silica synthesized by the pyrolysis method, silica nanoparticles treated by drying process (dried SiO₂), and 3-Aminopropyltriethoxysilane modified silica (APTES-modified SiO₂) nanoparticles. Fumed SiO₂ was purchased from Sigma-Aldrich and has a diameter of approximately 7 nm. The manufacturing method of the dried SiO₂ and APTES-modified SiO₂ are described below.

1.1 Method of Preparing Dried SiO2 Nanoparticles

The fumed SiO₂ nanoparticles are dried at 150° C. for 20 h to get dried SiO₂ nanoparticles. High temperature is used to decrease the isolated silanol groups on the silica surface by dehydration.

1.2 Method of Preparing 3-Aminopropyltriethoxysilane (APTES)-modified SiO₂

0.5 g of the dried SiO₂ nanoparticles prepared in the above process is suspended in 31.25 mL of methanol and sonicated for 30 min to get a silica-methanol solution. Then, the silica-methanol solution is added with 1.875 mL of APTES to get a mixed solution. The mixed solution contains 2 wt. % of dried SiO₂ nanoparticles, 91.5 wt. % of methanol, and 16.5 wt % of APTES. The mixed solvent is stirred continuously for 2 h at 50° C. The mixed solution is subsequently centrifuged at 10,000 rpm for 10 min to collect the precipitate, which is then dried for 24 hrs at 50° C. to get the silica powder product, the APTES-modified SiO₂ powder. The method mentioned above is sol-gel reaction in which APTES is employed to react with silanol groups on the dried SiO₂ surface in methanol. Methanol is used to support the reaction between the coupling agent APTES and silicas while to prevent over-formation of the Si(CH₂)₃NH₂ functional group on silica surface.

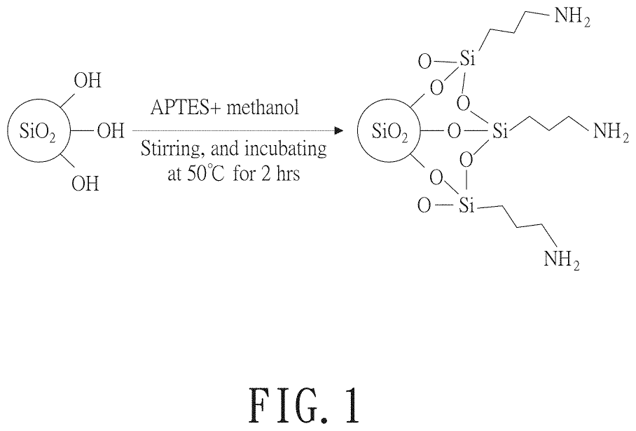

Refer to FIG. 1, in the silica particles modified by the coupling agent, APTES, siloxanes (Si—O—Si) are formed on the particles surface instead of OH groups, and amine groups (NH₂—) are added to silicon atom. Those functional groups partially replace a part of original silanol groups on the surface of fumed SiO₂ so that APTES-modified SiO₂ is easier to aggregate. At the same time, the interaction between the remaining silanols and amine groups on the surface of SiO₂, and siloxane bridges by hydrogen bonds also contribute to the aggregation of APTES-modified SiO₂ particles.

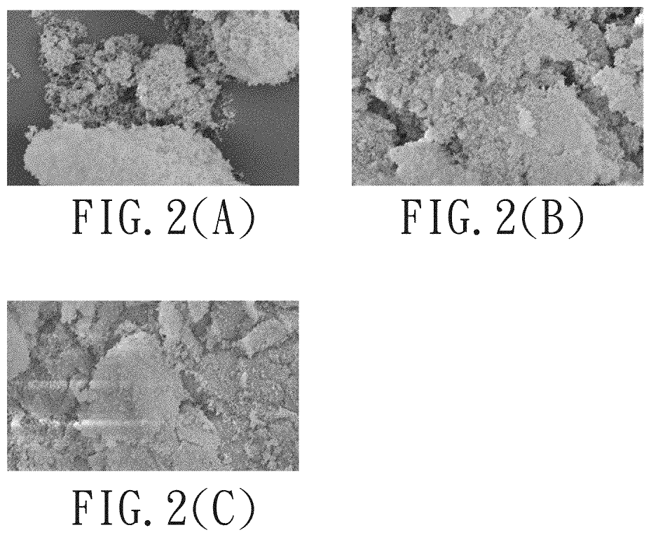

Refer to FIG. 2, field emission scanning electron microscope (FE-SEM) images showing the surface morphologies of the fumed SiO₂ nanoparticles, dried SiO₂ nanoparticles, and APTES-modified SiO₂ nanoparticles are revealed. As shown in FIG. 2(A), the fumed SiO₂ nanoparticles are isolated and not aggregated because they have high density of surface silanols, and a large portion of the silanols are hydrogen-bonded with each other on the same particles surface. Thus the surface of the fumed SiO₂ nanoparticles is highly reactive to water molecules. Moreover, the fumed SiO₂ nanoparticles has high surface energy so that they are highly hydrophilic on the particle surface and thus hardly interact with M-phenylenediamine (MPD) or 1,3,5-benzenetricarbonyl trichloride (TMC) monomers. Also refer to FIG. 2(B) and FIG. 2(C), the images show that aggregates are formed in both the dried SiO₂ nanoparticles and the APTES-modified SiO₂ nanoparticles, especially the latter. This result indicates that long time exposure at high temperature of the fumed SiO₂ nanoparticles can dehydrate and activate the silica particle surface, which leads to aggregate formation on the dried SiO₂ particles.

2. Preparation of FO Membrane

2.1 Preparation of Substrate Layer

In this embodiment, a substrate layer of FO membrane is made of polysulfone (PSf) and performed by phase inversion. A solution which contains 81.0 wt. % of methylpyrrolidone (NMP), 3 wt. % of LiCl, and 0.5 wt. % of polyvinylpyrrolidone (PVP) is sonicated for 30 min and then 15.5 wt % PSf material is added to obtain a mixed solution. The mixed solution is incubated at 60° C. by water bath and stirred for 16 hrs with a controlled humidity of 30-40% until the mixed solution turns into homogeneous and transparent. Next the solvent is degassed for 24 hrs to extract gasses from the solution and get a PSf solution. A casting knife (ZUA 2000 Zehntner-Universal Film Applicator, Zehntner GmbH Testing Instruments) is used to spread the PSf solution on a glass plate with a thickness of the PSf film as 200 μm. The glass plate is immediately immersed in a deionized water (DI-water) water bath for fabricating a PSf substrate by phase inversion. The obtained PSf substrate is cleaned with DI water several times and stored in DI water for further usage.

2.2 Preparation of Polyamide (PA) Layer

The preparation of a PA layer on the obtained PSf substrate is performed by interfacial polymerization. The prepared PSf film is heated at 80° C. for 8 min, then 20 mL of m-Phenylenediamine (MPD) solution is spread on the PSf substrate. After 3 min, the excessive MPD solution is removed by using a rubber knife and 20 mL of TMC solution is poured on to react with the residual MPD for 3 min. Then, the excessive TMC solution is removed by a rubber knife to get a PA layer. The PA layer obtained is dried in air for 5 min and subsequently cured at 80° C. for 5 min. Thereby the FO membrane is obtained and stored in DI water before usage.

In the above experiments, silica nanoparticles are added into the MPD solution for preparing different PA layers. The silica used can be fumed SiO₂, dried SiO₂, and APTES-modified SiO₂. A method of preparing a MPD solution containing SiO₂ nanoparticles is described in the following.

In the groups of fumed SiO₂ and dried SiO₂, fumed SiO₂ or dried SiO₂ is added into MPD solution and then sonicated at 30° C. for 1 hr and then stirred at room temperature for 30 min to get the MPD solution containing SiO₂.

As to the APTES-modified SiO₂ group, repeat four times of the process of “1 hr sonication and 30 min stirring at room temperature” until all APTES-modified SiO₂ particles are well dispersed in the MPD solution after adding APTES-modified SiO₂ into the MPD solution

Refer to Table 1, solution compositions of the respective FO membranes prepared by different dosages of silica are revealed. SDS is sodium dodecyl sulfate, and no addition means without addition of silica.

TABLE 1

| | MPD aqueous solution | | | | |
|---|---|---|---|---|---|
| | SiO₂ | | | DI | |
| | nanoparticles | MPD | SDS | water | TMC |
| | (wt. %) | (wt. %) | (wt. %) | (wt. %) | (w/v. %) |
| no addition | 0 | 2.0 | 0.1 | 97.90 | 0.15 |
| addition of | 0.05 | 2.0 | 0.1 | 97.85 | 0.15 |
| various types | 0.10 | 2.0 | 0.1 | 97.80 | 0.15 |
| of silica | 0.20 | 2.0 | 0.1 | 97.70 | 0.15 |
| nanoparticles | 0.40 | 2.0 | 0.1 | 97.50 | 0.15 |

The forward osmosis (FO) membrane prepared without the addition of SiO₂ particles is called as “control group”, while the groups of the FO membranes added with SiO₂ particles are labeled as “fumed SiO₂ group”, “dried SiO₂ group”, and “APTES-modified SiO₂ group”.

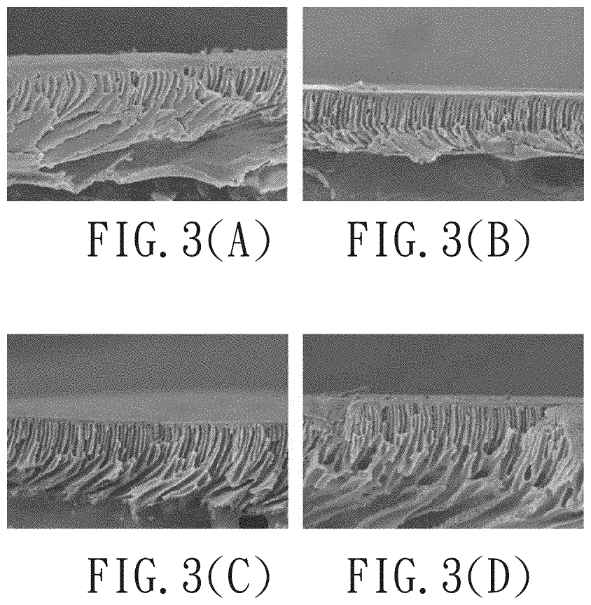

Refer to FIG. 3, FE-SEM images of cross section of the respective groups of the FO membranes are revealed. FIG. 3(A), FIG. 3(B), FIG. 3(C), and FIG. 3(D) are images of the control group, the fumed SiO₂ group, the dried SiO₂ group, and the APTES-modified SiO₂ group, respectively, with the dosage of silica nanomaterial as 0.1 wt. %. An average thickness of the FO membranes prepared is 60-90 μm and the PSf substrate layer has dense and long finger-like pores under the PA layer, implying good formation of the PSf substrate.

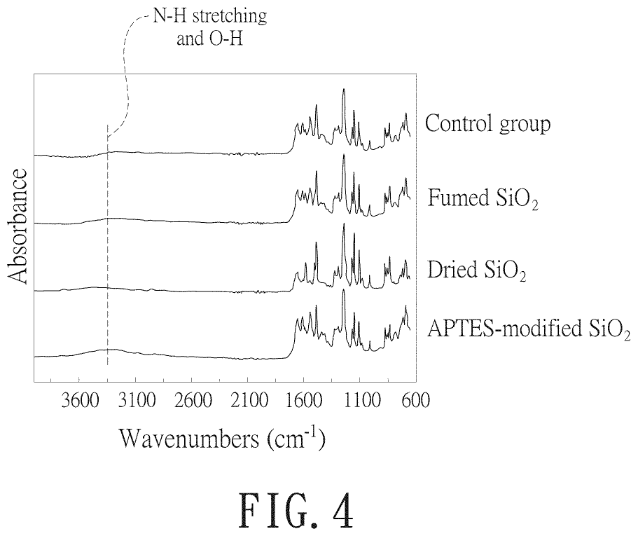

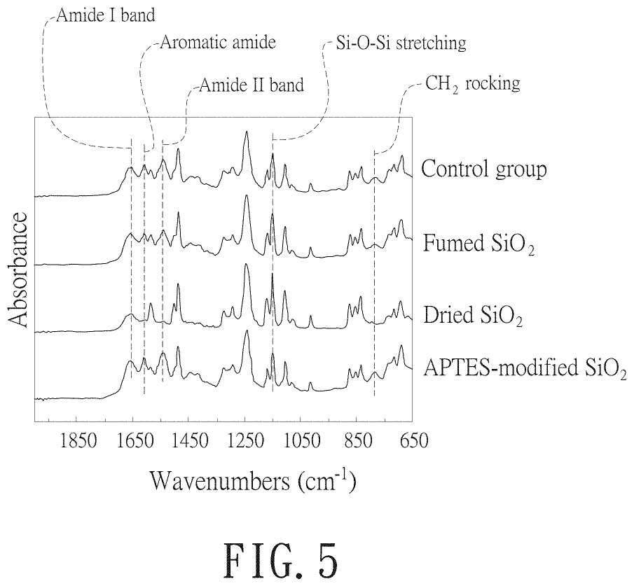

Refer to FIG. 4 and FIG. 5, attenuated total reflectance Fourier transform infrared (ATR-FTIR) spectra of the respective groups of the FO membranes are revealed. FIG. 4 is the full scan ATR-FTIR spectra with the wavenumbers in the range of 650-4000 cm⁻¹ while FIG. 5 is the zoom-in ATR-FTIR spectra with the wavenumbers in the range of 650-2500 cm⁻¹. These spectra represent the characteristics of the PA layer and an interface between the PA layer and the PSf substrate layer because the ATR-FTIR has a penetration depth of 5 μm at the surface of test samples. As shown in FIG. 4, the primary amide I band (C═O stretching) at 1663 cm⁻¹, the aromatic amide (N—H) at 1609 cm⁻¹, and the amide II band (C—N stretching) at 1545 cm⁻¹ are observed. This indicates that the PA layer is successfully formed by the present method. In FIG. 4, the broaden peaks of O—H and N—H stretching groups between 3100 and 3600 cm⁻¹ are also observed, which indicates that the PA layer also includes these two functional groups. The spectrum of the APTES-modified SiO₂ group also displays a broad peak in FIG. 4, which might be owing to formation of hydrogen bonds between silicas and polymers of the membrane. This bonding increases the hydrophilicity of the FO membrane

Refer to FIG. 5, the spectra of the APTES-modified SiO₂ group also exhibits CH₂-rocking peak at 780 cm⁻¹, which is formed during the process of APTES modification. The intensity of the C—N characteristic peaks is also increased in the APTES-modified SiO₂ group. The result indicates that SiO₂ nanoparticles can be bonded to the PA layer by interfacial polymerization.

The absorption band at 1152 cm⁻¹ indicates the formation of disiloxane (Si—O—Si) bands in the FO membranes prepared with SiO₂ nanoparticles. Yet, the absorption band mentioned above overlaps with the peaks of the symmetric SO₂ stretching vibrations of the SO₂ sulfone groups in the PSf substrate. Thus, the absorption band also shows in the control group. Moreover, the changes in the elemental compositions ofthe respective groups of the FO membranes are measured by using Energy-dispersive X-ray spectroscopy (EDS), and the results are shown in Table 2. The detection of Si element in all the FO membranes measured indicates successful incorporation of SiO₂ nanoparticles into the PA layer of the FO membranes. The C, N and O detected are compositional elements in both the PA layer and the PSf substrate layer while the S detected is the compositional element in the PSf substrate layer. In the APTES-modified SiO₂ group, an increase in the oxygen element is observed, which could be resulted from the formation of siloxanes and dehydration of silanols on surface of the SiO₂ nanoparticles (as shown in FIG. 1).

TABLE 2

| | | | | APTES-modified |
|---|---|---|---|---|
| FO Membrane | | Fumed SiO₂ | Dried SiO₂ | SiO₂ |
| Weight (%) | C | 64.23 | 69.07 | 66.77 |
| | N | 3.15 | 0.98 | 2.38 |
| | O | 9.78 | 10.87 | 11.22 |
| | Si | 0.89 | 0.34 | 0.72 |
| | S | 21.95 | 18.73 | 18.90 |
| Atomic (%) | C | 77.50 | 81.04 | 78.90 |
| | N | 3.26 | 0.99 | 2.41 |
| | O | 8.86 | 9.57 | 9.95 |
| | Si | 0.46 | 0.17 | 0.36 |
| | S | 9.92 | 8.23 | 8.37 |

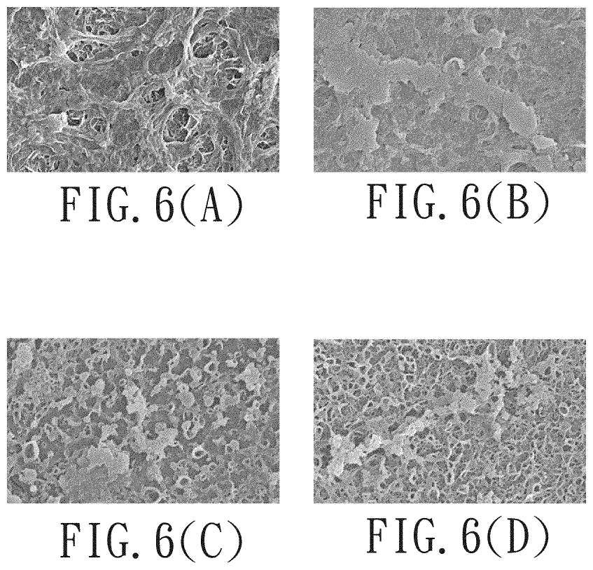

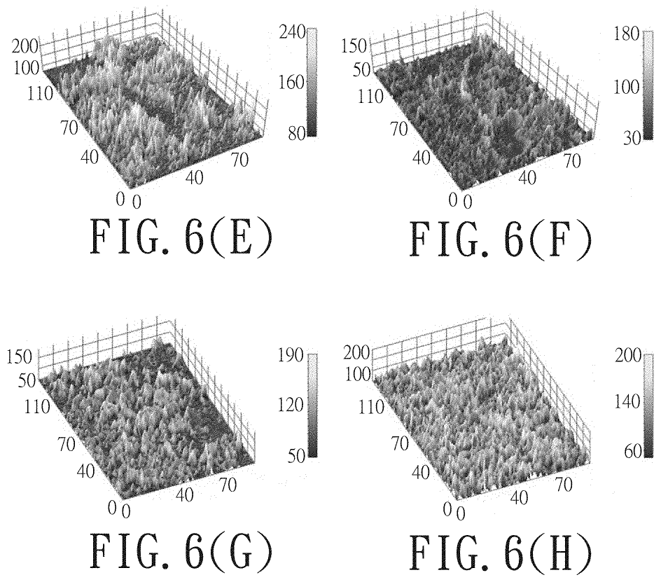

Refer to FIG. 6, scanning electron microscopic (SEM) micrograph and 3D images of the surface morphologies of the respective groups of the FO membranes are disclosed. The surface roughness of the FO membranes is determined from the SEM micrograph by using the Image J software and represented by root mean square deviation (R_{q}) and arithmetical mean deviation (Rₐ). As to analysis results, please refer to Table 3. With reference to FIG. 6(A) and FIG. 6(E), the PA layer of the control group exhibits ridge-valley structures on the surface with some protuberances. As shown in Table 3, the R_{q} value of the control group is 41.3 μm. Refer to FIG. 6(B) and FIG. 6(F), there is a significant reduction in protuberances on the surface of the PA layer of the fumed SiO₂ group compared with the control group. Silica agglomeration is observed on the surface of the PA layer. This agglomeration leads to the decreased formation of the ridge-valley structures on the PA layer and formation of relatively smooth surface microstructures, and thus reduces an effective filtration area on the membrane surface. Also refer to Table 3, the R_{q} value of the fumed SiO₂ group is 22.8 μm, which is lower than that of the control group. This means that the fumed SiO₂ group of the FO membrane exhibits a lower surface roughness than the control group. FIG. 6(C) and FIG. 6(G) are SEM images of the dried SiO₂ group while FIG. 6(D) and FIG. 6H are SEM images of the APTES-modified SiO₂ group. These SEM images of the two groups show that nodular structures are increasingly formed on the surfaces, and the amount of nanoparticle agglomeration is decreased considerably. The R_{q} value of the dried SiO₂ group is 33.8 μm, which is lower than that of the control group. This indicates that the roughness of the dried SiO₂ group is also lower than that of the control group. Dried SiO₂ nanoparticles still have quite a lot silanol groups on the surfaces similar to the fumed SiO₂ nanoparticles. But these silanol groups are activated to react with matrix components of the PA layer and further decrease hydrogen bonding of the silanol groups with each other. Thereby nanoparticle agglomeration on the surface of the PA layer is further reduced.

Refer to FIG. 6(D) and FIG. 6(H), compared with other groups, the APTES-modified SiO₂ group has a rougher surface with ridge-valley microstructures, which enhance the permeability of the FO membrane. Although the Si(CH₂)₃NH₂ functional group on the surface of the APTES-modified silica nanoparticles increases the dispersion capacity of APTES-modified silica nanoparticles in the aqueous solution by reducing the number of surface silanol, not all the silanol groups on the APTES-modified silica nanoparticles are replaced. The remaining silanols enable the aggregation of APTES-modified silica nanoparticles on the surface of the PA layer. As shown in Table 3, the R_{q} value of the APTES-modified SiO₂ group is 39.4 μm, which is similar to that of the control group. This means that the surface roughness of the APTES-modified SiO₂ group is similar to that of the control group.

Table 3 also shows the analytic results of contact angles of the respective groups of the FO membrane. In order to measure the contact angle, DI water is dropped on five random locations on the PA layer of the FO membrane, and the contact angles of the water droplets are measured and averaged. The result obtained represents the surface hydrophilicity of the FO membrane. As shown in Table 3, the groups of the FO membranes added with SiO₂ particles all have lower contact angles than that of the control group. The results indicate that the addition of silica increase the hydrophilicity of the FO membrane. The fumed SiO₂ group exhibits the contact angle of 48.7°+0.9°, which is only a bit lower than that of the control group. The contact angle of the dried SiO₂ group is 51.6°±1.3°, similar to that of the control group while the APTES-modified SiO₂ group has the lowest contact angle value (35.0°±2.5°), which means the highest hydrophilicity.

TABLE 3

| PA layer of FO | Surface | R_{q} | Rₐ | Contact angle |
|---|---|---|---|---|
| membrane | morphology | (μm) | (μm) | (°) |
| Control | Rigid-valley | 41.3 | 32.4 | 52.0 ± 1.2 |
| Fumed SiO₂ | Smooth valley | 22.8 | 17.2 | 48.7 ± 0.9 |
| Dried SiO2 | Smooth valley | 33.8 | 28.0 | 51.6 ± 1.3 |
| APTES-modified | Rigid-valley | 39.4 | 32.3 | 35.0 ± 2.5 |
| SiO₂ | | | | |

3. Filtration Experiments of FO Membrane

3.1 Test Model

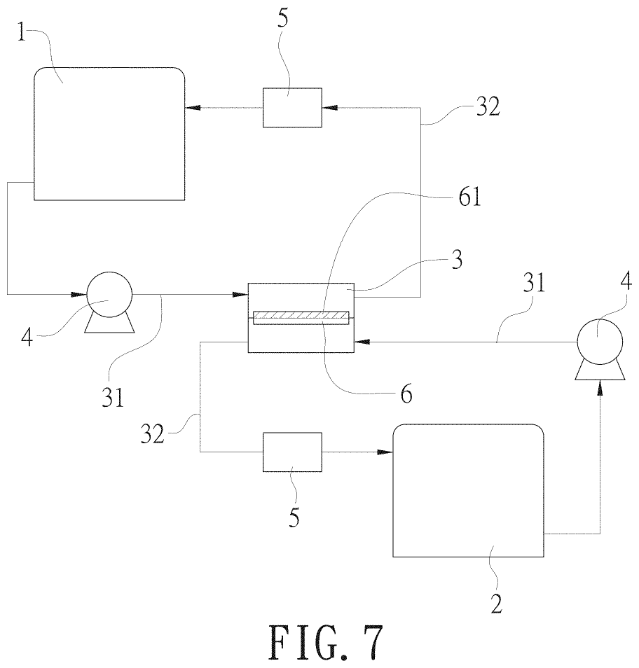

The experiments are carried out by using a filtration module. Refer to FIG. 7, the filtration module used includes a feed tank (1), a draw tank (2), and a membrane cell (3) provided with inlet channels (31) on two sides for connecting to the feed tank (1) and the draw tank (2) respectively. A liquid contained in the feed tank (1) is feed solution (FS) and that in the draw tank (2) is draw solution (DS).

Moreover, the membrane cell (3) further connects to two peristaltic pumps (4), which are employed to drive the FS and the DS flowing from the feed tank (1) and the draw tank (2) to the membrane cell (3) and maintain a flow rate of both solutions at 200 mL/min. The membrane cell (3) is provided with two outlet channels (32) connected to the feed tank (1) and the draw tank (2) for allowing counter flows of the FS and the DS, respectively. A conductivity meter (5) is arranged at each of the outlet channels (32) for measuring conductivity of the FS and the DS flowing from the membrane cell (3) back to the feed tank (1) and the draw tank (2), respectively. During the experiments, a FO membrane (6) with an effective area of 40 cm² is placed in the membrane cell (3), and a PA layer (61) of the FO membrane (6) is orientated facing one side with the inlet channel (31) connected to the feed tank (1). The temperature is maintained at 25° C. throughout the experiment.

During the experiment, weight changes of the FS in the feed tank (1) are recorded at regular sampling intervals in order to calculate water permeate flux [Jw, L/m²·h (LMH)] of the FO membrane (6) according to the following equation.

$${J}_{w} = \frac{Δ mfeed / ρ feed}{Δ t \times Am}$$

wherein Δm_{feed} is the weight change of the FS (kg) in the feed tank (1), ρ_{feed} is the density of the FS (kg/m³) in the feed tank (1), Δt is the sampling time interval (h), and Aₘ is the effective area (m²) of the FO membrane (6).

Wight changes of the FS flowing from the membrane cell (3) back to the feed tank (1) are recorded at regular sampling intervals to calculate reverse salt flux [Jₛ, mol/m²−h (nMH)] according to the following equation

$${J}_{s} = \frac{Cf , t \times Vft - Cf , i \times V , i}{Δ t \times Am}$$

wherein C_{f,0} and C_{f,t} (M, mol/L) are the salt concentrations of the FS in the feed tank (1) at the beginning of the test and at time t during the test, respectively, and V_{f,0} and V_{f,t} (L) are the volumes of the FS in the feed tank (1) at the beginning of the test and at time t during the test, respectively, Δt is the sampling time interval (hr), and Aₘ is effective area (m²) of the FO membrane (6).

3.2 Water Treatment Performance of the FO Membrane

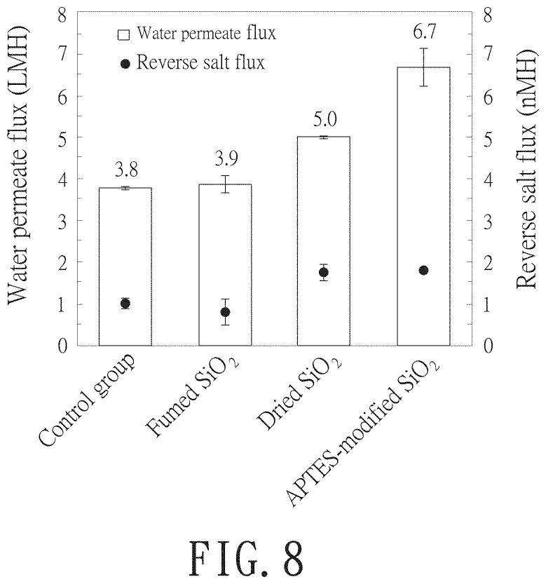

Refer to FIG. 8, filtration test results of the respective FO membranes prepared are disclosed. The liquid contained in the feed tank (FS) (1) is DI water and the liquid contained in the draw tank (DS) (2) is 1 M NaCl. All the experiments are run in 1 hr with a sampling interval of 10 min.

According to FIG. 8, the APTES-modified SiO₂ group has the highest water permeate flux (6.7 LMH), which is 76.7% higher than that of the control group. The water permeate flux of the dried SiO₂ group and the fumed SiO₂ group is 32.0% and 2.4% higher than that of the control group, respectively. The results indicate that the addition of highly hydrophilic SiO₂ nanoparticles into the PA layer of the FO membranes increases membrane hydrophilicity, which further result in an increase in the water permeate flux of the FO membranes. The water permeate flux of the dried SiO₂ group is significantly increased. The dehydration and rearrangement of silanol groups on the surface of the dried silica being treated by high temperature (150° C.) and dehydrated may attribute to this phenomenon.

Refer to the analytical results of the reverse salt flux in FIG. 8, the reverse salt flux of the dried SiO₂ group and the APTES-modified SiO₂ group is marginally higher than that of the control group and the finned SiO₂ group.

Because the dried SiO₂ group and the APTES-modified SiO₂ group exhibit higher water permeate flux, their water treatment performance is further analyzed by using different silica concentration in the PA layer of the FO membrane.

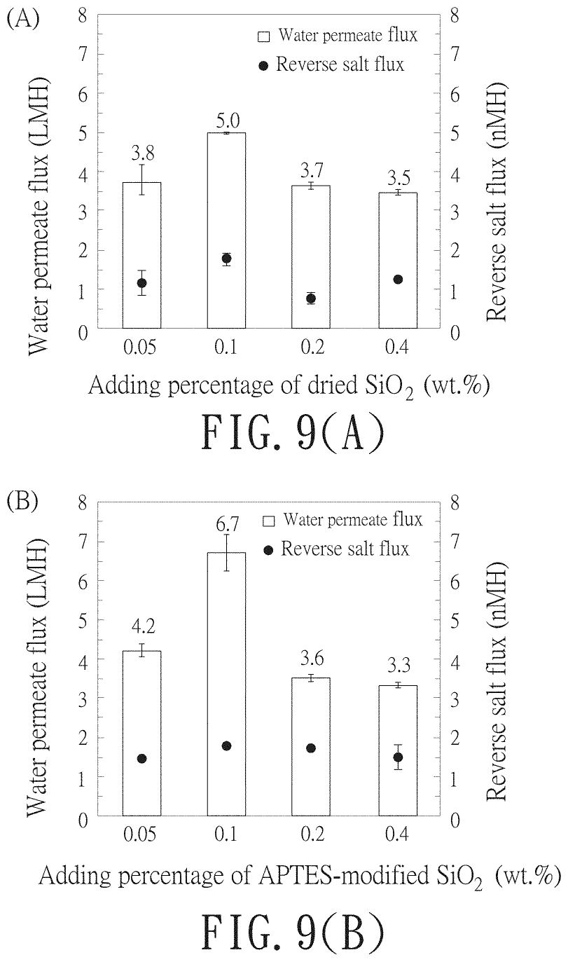

Refer to FIG. 9(A) and FIG. 9(B), test results of the FO membranes prepared by the addition of different dosages of dried SiO₂ or APTES-modified SiO₂ are displayed. The liquid contained in the feed tank (FS)(1) is DI water and the liquid contained in the draw tank (DS) (2) is 1 M NaCl. All the experiments are run in 1 h with a sampling interval of 10 min.

As shown in FIG. 9(A), the water permeate flux is increased from 3.8 LMH to 5.0 LMH when the dosage of the dried SiO₂ added is increased from 0.05 wt. % to 0.1 wt. %. With an increase in the dried SiO₂ over 0.1 wt. %, the water permeate flux is not increased but reduced to that of the control FO membrane (also refer to FIG. 8). Also refer to FIG. 9(B), the water permeate flux is improved from 4.2 LMH to 6.7 LMH when the dosage of APTES-modified SiO₂ is increased from 0.05 wt % to 0.1 wt %. Similar to the dried SiO₂ group, the water permeate flux is no more increased when the dosage of APTES-modified SiO₂ added is increased up to over 0.1 wt. %. The water permeate flux of the APTES-modified SiO₂ group is also similar to that of the control FO membrane (also refer to FIG. 8). The reverse salt flux of the FO membranes added with different dosages of dried SiO₂ or APTES-modified SiO₂ remains relatively stable. The water permeate flux of the FO membrane prepared with addition of 0.1 wt. % of APTES-modified SiO₂ is higher than that of the FO membrane prepared with addition of 0.1 wt. % of dried SiO₂. Therefore, the FO membrane with 0.1 wt. % of APTES-modified SiO₂ is used for tests of wastewater recovery and separation evaluation.

3.3 Wastewater Recovery and Separation Test

In the tests, the liquid in the feed tank (1) is aquaculture wastewater and the liquid in the draw tank (2) is either seawater or 1 M NaCl. There are two aquaculture wastewaters which are obtained from two fishpond systems of the orange-spotted groupers (Epinephehus coioides) at the campus of National Kaohsing University of Science and Technology (Nanzih District, Kaohsing, Taiwan). Every 24 h, the liquid in the feed tank (1) is sampled and tested for the assessment of wastewater recovery and separation performance of the FO membrane. Each test is run until the conductivity of the liquid in the feed tank (1) is increased and equal to that of the liquid in the draw tank (2). Then all components and the FO membrane contained in the filtration module are thoroughly cleaned by DI water and methanol, and stored in DI water for further analysis.

Two conductivity meters (Suntex SC-2300 and multiparameter EC/TDS/salinity meter, Hanna Instruments) are used for measuring conductivity of the FS and the DS, respectively, to obtain the reverse salt flux. For the assessment wastewater separation performance of the FO membrane, pH value, temperature, 5-day biological oxygen demand (BOD₅), nitrite (NO₂⁻) concentration, nitrate (NO₃) concentration, ammonia (NH) concentration and suspended solid (SS) concentration are measured at the beginning and the end of the test, respectively.

In addition, FO membrane without adding SiO₂ (control group) and FO membrane prepared with addition of 0.1 wt. % of APTES-modified SiO₂ (APTES-modified SiO₂ group) are used in this test. Referring to Table 4, three test conditions are used, and the characteristics of the aquaculture wastewaters as FS and 1 M NaCl and seawater as DS are disclosed in Table 5. In Table 5, if NO₂ concentration is records as “<0.02”, it means that the NO₂ concentration is lower than the detection limit.

TABLE 4

| | | | Sampling | Total |
|---|---|---|---|---|
| | FS | DS | interval | testing time |
| Test 1 | Aquaculture | 1M NaCl | 12 hrs | 168 hrs |
| | wastewater 1 | | | (7 days) |
| Test 2 | Aquaculture | 1M NaCl | 12 hrs | 156 hrs |
| | wastewater 2 | | | (6.5 days) |
| Test 3 | Aquaculture | Seawater | 12 hrs | 120 hrs |
| | wastewater 2 | | | (5 days) |

TABLE 5

| | | Conductivity | SS | NH₃⁻ | NO₃⁻ | NO₂⁻ | BOD₅ |
|---|---|---|---|---|---|---|---|
| | pH value | (mS/cm) | (mg/L) | (mg/L) | (mg/L) | (mg/L) | mg/L) |
| 1M NaCl | 5.6 | 86.0 | — | — | — | — | — |
| Seawater | 8.5 | 50.5 | 1.50 | 0.55 | 0.55 | <0.02 | 7.3 |
| Aquaculture | 8.5 | 31.3 | 3.50 | 0.16 | 5.12 | <0.02 | 5.8 |
| wastewater 1 | | | | | | | |
| Aquaculture | 6.5 | 15.5 | 7.83 | 2.10 | 6.48 | 0.14 | 7.3 |
| wastewater 2 | | | | | | | |

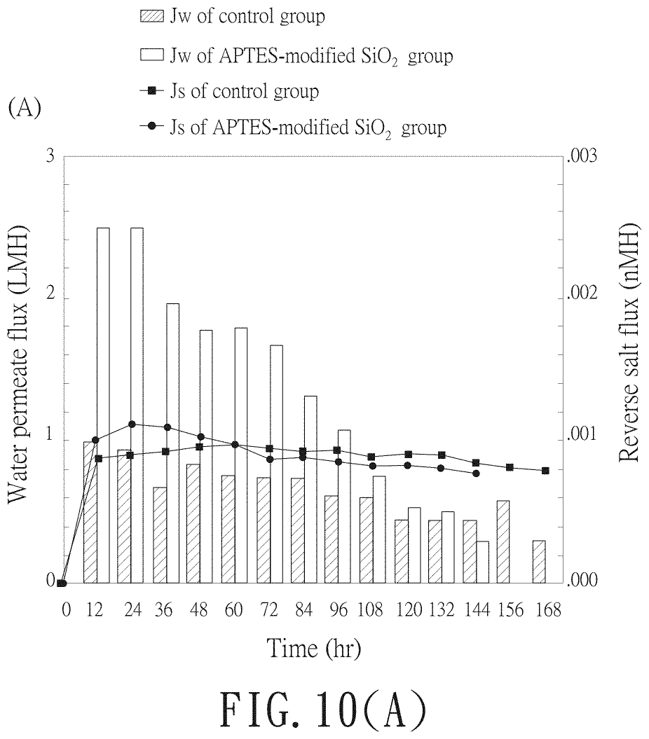

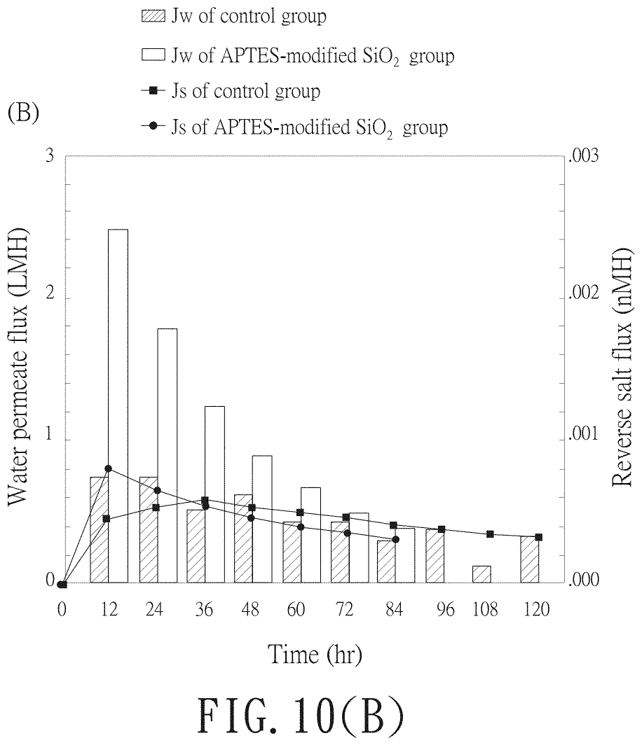

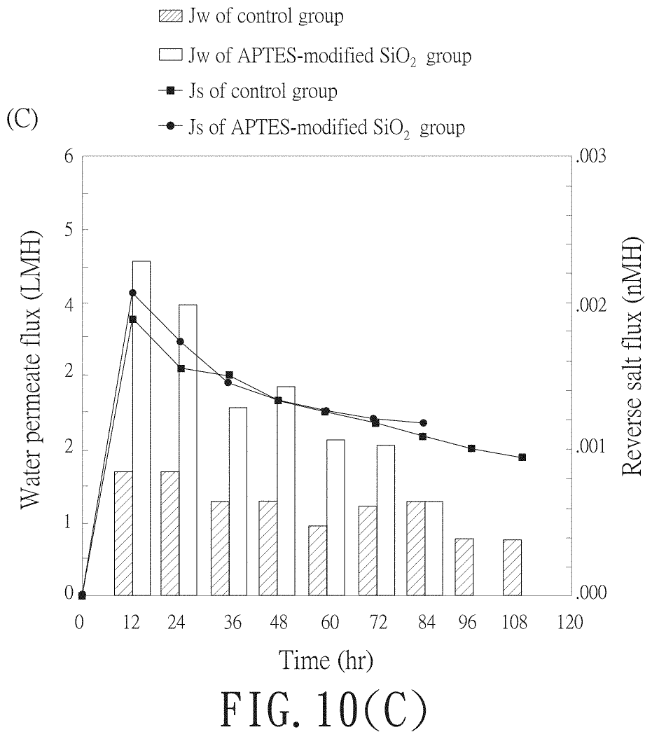

FIG. 10(A) to FIG. 10(C) respectively disclose the testing results of Test 1 to Test 3 in Table 4. The water permeate flux (J_{w}) of the two FO membranes are lower than that in FIG. 9 because the FS used in the three tests are aquaculture wastewaters, which have more impurities than the FS (DI water) used in FIG. 9. Moreover, in the three tests, both J_{w} and Jₛ of the two FO membranes reach to a highest value within 48 hrs after the beginning of test, and the J_{w} and Jₛ thereof are gradually decreased and maintain at a constant level.

According to FIG. 10, within 24 hrs after the beginning of the test, the water permeate flux of the FO membrane prepared with APTES-modified SiO₂ is 60-70% higher than the water permeate flux of the FO membrane in the control group. It indicated that the FO membrane prepared with APTES-modified SiO₂ has a better separation performance within a shorter processing time. FIG. 10 also shows that the J_{w} and Jₛ of the FO membrane with APTES-modified SiO₂ is gradually and stably decreased after 24 hrs. In addition, there is no statistically significant difference between the Jₛ value of the control group and the APTES-modified SiO₂ group. Therefore, the FO membrane of the APTES-modified SiO₂ group has a better selectivity and separation performance compared to the control group due to higher water permeability and lower reverse salt flux.

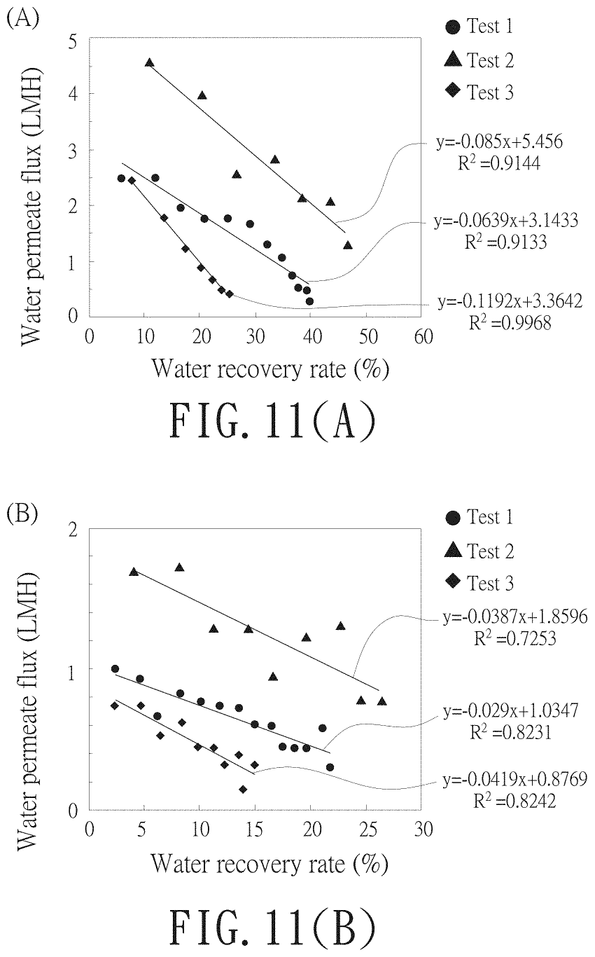

FIG. 11 (A) shows the regression analyzing diagram of water permeate flux versus water recovery rate of FO membrane without adding SiO₂ (control group), and FIG. 11 (B) shows FO membrane prepared with the addition of 0.1 wt. % of APTES-modified SiO₂(APTES-modified SiO₂ group). The results indicate that there is a negative correlation between water permeate flux and water recovery rate. Refer to FIG. 11(B), the regression curve of the APTES-modified SiO₂ group has a higher slope than the regression curve of the control group. Further, salinity of the FS also influences water permeate flux of the FO membrane. FS with high salinity leads to the occurrence of concentration polarization effect on the surface of the FO membrane so as to decrease water permeate flux. Therefore, separation performance of the FO membrane is also negatively correlated to the salinity of the FS.

The salinity of the FS also influences the water permeate flux of the FO membrane when conducting the filtration experiment. FIG. 11(A), FIG. 11(B) and FIG. 11(C) respectively show water separation results in which the DS is 1 M NaCl and seawater. The Test 3 has a lowest initial water permeate flux because the DS used in Test 3 is seawater with conductivity of 50.5 ms/cm, lower than the conductivity of 1 M NaCl (84.0 ms/cm). Therefore, the water permeate flux and water recovery are decreased in the order of Test 2>Test 1>Test 3 because 1 M NaCl has a higher osmotic pressure and can increase water permeate flux of the FO membrane. As the testing time increases, concentration of the DS is gradually diluted since osmosis water continuously flows into the draw tank. Further, operation time needed to complete water filtration under the test condition of Test 3 is shortest among the three tests due to a low osmotic pressure of the DS and a high water permeate flux of the FO membrane prepared with APTES-modified SiO₂. It only needs 84 hrs to complete water treatment for test 3. Therefore, the FO membrane prepared with APTES-modified SiO₂ is promising for wastewater treatment and recovery.

Table 6 discloses water quality analysis result of the FS in the three tests after the experiment is completed. “V” in Table 6 represents the control group and the “A” in table 6 represents the APTES-modified SiO₂ group. When the value of BOD₅ is decreased, it indicates that partial pollutants are degraded by microorganisms. In test 1, NO₂⁻ concentration of FS after filtration in the APTES-modified SiO₂ group is significantly higher than the concentration in the control group. However, NO₂-concentration of FS after filtration in the APTES-modified SiO₂ group in test 2 and test 3, are all lower than the concentration of the control group. A possible reason for this result is that the whole operation time of test 1 is longest (approximately 7 days) and the water recovery rate and the membrane separation effect are highest in test 1, which leads to block and concentrate most of the compositions in the wastewater in the feed tank.

TABLE 6

| | | | Conductivity | NH₃⁻ | NO₂⁻ | BOD₅ |
|---|---|---|---|---|---|---|
| | | pH value | (mS/cm) | (mg/L) | (mg/L) | mg/L) |
| Test 1 | V | 6.8 | 74.3 | 0.02 | <0.02 | 2.8 |
| | A | 6.4 | 91.0 | 0.04 | 1.10 | 1.8 |
| Test 2 | V | 7.3 | 55.9 | 0.40 | <0.02 | 1.7 |
| | A | 7.5 | 83.6 | 0.04 | <0.02 | 2.2 |
| Test 3 | V | 8.4 | 32.5 | 0.20 | <0.02 | 2.4 |
| | A | 7.7 | 33.8 | <0.02 | 0.09 | 0.5 |

In conclusion, the forward osmosis membrane containing silica nanoparticles and a manufacturing method of the same in the present invention, manufactures a polyamide layer on a substrate layer by interfacial polymerization in which silica nanoparticles, especially APTES-modified silica nanoparticles, are added in the polyamide layer to obtain the forward osmosis membrane. The FO membrane prepared with silica nanoparticles has high water permeate flux, low reverse solute flux and high selectivity. In addition, water recover rate of the FO membrane prepared with silica nanoparticles reaches 47% after 84 hrs water treatment which is much higher than the water recovery rate of the forward osmosis membrane prepared without silica nanoparticles (26%).

Therefore, the forward osmosis membrane containing silica nanoparticles of the present invention can be well applied in wastewater recovery with proper draw solution and increases the efficiency of wastewater recycling and reuse.

What is claimed is:

1. A forward osmosis (FO) membrane containing silica nanoparticles, comprising a substrate layer and a polyamide layer disposed on the substrate layer, wherein the polyamide layer comprises a plurality of silica nanoparticles.

2. The FO membrane containing silica nanoparticles as claimed in claim 1, wherein the polyamide layer comprises 0.5 to 1.5 wt % of the silica nanoparticles.

3. The FO membrane containing silica nanoparticles as claimed in claim 1, wherein the silica nanoparticles are 3-aminopropyltriethoxysilane modified silica nanoparticles.

4. The FO membrane containing silica nanoparticles as claimed in claim 2, wherein the silica nanoparticles are 3-aminopropyltriethoxysilane modified silica nanoparticles.

5. The FO membrane containing silica nanoparticles as claimed in claim 1, wherein the substrate layer is made of polysulfone.

6. The FO membrane containing silica nanoparticles as claimed in claim 1, wherein the FO membrane containing silica nanoparticles has a thickness ranging from 60 to 90 μm.

7. A manufacturing method for a forward osmosis (FO) membrane containing silica nanoparticles, comprising steps of:
(a) preparing a substrate layer; and
(b) manufacturing a polyamide layer on the substrate layer by interfacial polymerization, wherein the polyamide layer comprises a plurality of silica nanoparticles.

8. The manufacturing method as claimed in claim 7, wherein the polyamide layer comprises 0.5 to 1.5 wt % of the silica nanoparticles.

9. The manufacturing method as claimed in claim 8, wherein the silica nanoparticles are 3-aminopropyltriethoxysilane modified silica nanoparticles.

10. The manufacturing method as claimed in claim 7, wherein the substrate layer is made of polysulfone.

11. The manufacturing method as claimed in claim 1, wherein the FO membrane containing silica nanoparticles has a thickness ranging from 60 to 90 μm.
